(19) United States
(12) Patent Application Publication
(10) Pub. No.: US 2020/0401664 A1
(43) Pub. Date: Dec. 24, 2020

(54) REAL-TIME WEBSITE TRANSLATOR PLUGIN

(71) Applicants: Jordan Abbott ORLICK, Chatsworth, CA (US); Matthew Jason WEISMAN, West Hills, CA (US)

(72) Inventors: Jordan Abbott ORLICK, Chatsworth, CA (US); Matthew Jason WEISMAN, West Hills, CA (US)

(21) Appl. No.: 16/446,346

(22) Filed: Jun. 19, 2019

(51) Int. Cl. G06F 17/28; H04L 29/08; H04L 29/06

(52) U.S. Cl. CPC G06F 17/289; H04L 65/40; H04L 67/02

(57) ABSTRACT

A real-time website translation method includes detecting, at a computing device, a native language of the computing device. The method also includes detecting, at the computing device, a request to load a website on a browser of the computing device. The method further includes transmitting text from the website, an indication of the native language, and an indication of a website language to a first server. Furthermore, the method includes receiving, from the first server, the text translated to the native language and displaying the website in the native language.

### TECHNICAL FIELD

The present disclosure generally relates to translating messages between users. More specifically, the present disclosure relates to translating, in real-time, some or all website content into a preferred language of the viewer.

### BACKGROUND

As globalization continues, it is increasingly likely that communication will cross national boundaries, and as a result, users will encounter language barriers. Conventional web page translators specify an installation of software, such as a browser plugin. In some cases, the browser plugin is exclusive to the browser. For example, a plugin of a first web browser (e.g., Google Chrome) does not translate pages in a different web browser (e.g., Firefox). Accordingly, a user may have to download multiple plugins.

### SUMMARY

According to one aspect of the present disclosure, a real-time website translation method includes detecting a native language of a computing device. The method also includes detecting a request to load a website on a browser of the computing device. The method also includes transmitting text from the website, an indication of the native language, and an indication of a website language to a first server. The method further includes receiving, from the first server, the text translated to the native language. Furthermore, the method includes displaying the website in the native language.

Another aspect discloses a real-time website translation apparatus that includes a memory and at least one processor coupled to the memory. The processor(s) is configured to detect a native language of a computing device and to detect a request to load a website on a browser of the computing device. The processor(s) is also configured to transmit text from the website, an indication of the native language, and an indication of a website language to a first server. The processor(s) is further configured to receive, from the first server, the text translated to the native language. Furthermore, the processor(s) is configured to display the website in the native language.

According to another aspect of the present disclosure, a real-time website translation method includes detecting, at a first server, a native language of a computing device. The method also includes detecting, at the first server, a request to load a website on a browser of the computing device. The method also includes receiving text of the website, an indication of the native language, and an indication of a website language transmitted from the computing device. The method further includes transmitting, to the computing device, the text translated to the native language to be displayed at the computing device.

Yet another aspect discloses a real-time website translation apparatus that includes a memory and at least one processor coupled to the memory. The processor(s) is configured to detect a native language of a computing device. The processor(s) is also configured to detect a request to load a website on a browser of the computing device. The processor(s) is further configured to receive text of the website, an indication of the native language, and an indication of a website language transmitted from the computing device. Furthermore, the processor(s) is configured to transmit the text translated to the native language to be displayed at the computing device.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates a computer network for use with website translation processing, according to one aspect of the present disclosure.

FIG. 2 is a block diagram conceptually illustrating a computing device, according to one aspect of the present disclosure.

FIG. 3 is a block diagram conceptually illustrating example components of a server, according to aspects of the present disclosure.

FIG. 4 illustrates a system for translating, in real-time, some or all website content into a preferred language of a viewer, according to aspects of the present disclosure.

FIG. 5 depicts a simplified flowchart of a method for translating, in real-time, some or all website content into a preferred language of the viewer, according to aspects of the present disclosure.

FIG. 6 depicts a simplified flowchart of a real-time website translation 600, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

As globalization continues, it is increasingly likely that communication will cross national boundaries, and as a result, users will encounter language barriers. Conventional web page translators specify an installation of software, such as a browser plugin. In some cases, the browser plugin is exclusive to the browser. For example, a plugin of a first web browser (e.g., Google Chrome) does not translate pages in a different web browser (e.g., Firefox). Accordingly, a user may have to download multiple plugins. Furthermore, in conventional systems, the user has to select a language to which the website content is to be translated. Additionally, conventional translation plugins translate an entire site and cannot selectively translate.

Aspects of the present disclosure are directed to translating, in real-time, some or all website content into a preferred language of a user or viewer. For example, real-time is an actual time elapsed in the performance of a computation by a computer, the result of the computation being required for the continuation of a physical process. The preferred language may correspond to a native language of a computing device (e.g., a user equipment, mobile device, or personal computer). The computing device includes real-time website translation application (RWTA) features, according to aspects of the present disclosure. The computing devices may include a website translation module to facilitate communication with a RWTA server. For example, a user of the computing device may subscribe to a translation service that causes the computing device to operate according to aspects of the present disclosure.

In one aspect of the present disclosure, the translation is based on a language of the computing device of the user. The language may be set in the computing device settings. The device language determines the translation language. For example, the language associated with the computing device may be detected (e.g., by the computing device) based on a language setting in a language setting module and communicated to a real-time website translation application (RWTA) server for translation of some or all of the website content into the user's native language.

Alternatively, the device language may be determined remotely (e.g., at the RWTA server). In somer aspects, RWTA server determine the language of the computing device or determine the preferred language of the user without receiving the information from the computing device. For example, the user subscribing to the system may provide a preferred language setting during setup.

A request for loading a website on a browser of the computing device is determined. The determination may be made by the computing device. For example, after detecting the preferred language (e.g., the RWTA server receives the preferred language of the computing device or user), text associated with or downloaded from the website to the computing device is transmitted to the RWTA server. The text may be text from code (e.g., hypertext markup language (HTML) code) used to generate the content of the website. The text may include all or part of the content of the website.

The RWTA server passes the text to a translation server for translation. In one aspect, the translation server and the RWTA server are integrated into a single server. In other aspects, the translation server is separate but coupled to the RWTA server. In another aspect, the translation server may be a third party translation server. In addition to the text, the RWTA server sends a “to” and “from” indicator. The “from” indicator indicates the source language and the “to” indicator indicates the translation language. The translation server then returns the translated text to the computing device via the RWTA server. The translated text replaces original text of the website. Thus, the translated text is received by the computing device and displayed in the native language at an interface of the computing device.

Translating some or all website content into a preferred/native language of a user or viewer are performed without user input. For example, the detecting of the native language, the determining of a request to load a website on a browser of the computing device, the transmitting of text from the website, transmitting of an indication of the native language, the transmitting of an indication of the website language to the RWTA server, the receiving of the text translated to the native language, and the displaying of the website in the native language are performed automatically and without user input.

In one aspect, translating some or all website content into a preferred language of a user without user input includes implementing or subscribing to (by a website owner) a website translation implementation described herein. For example, the translation may be implemented via HTML code added to the website's code and associated with a server. The HTML code may be added to translate the entire page or only a portion of the page. The system determines the language of the website to populate the “from” field described above. The system also determines the device's native language to populate the “to” field.

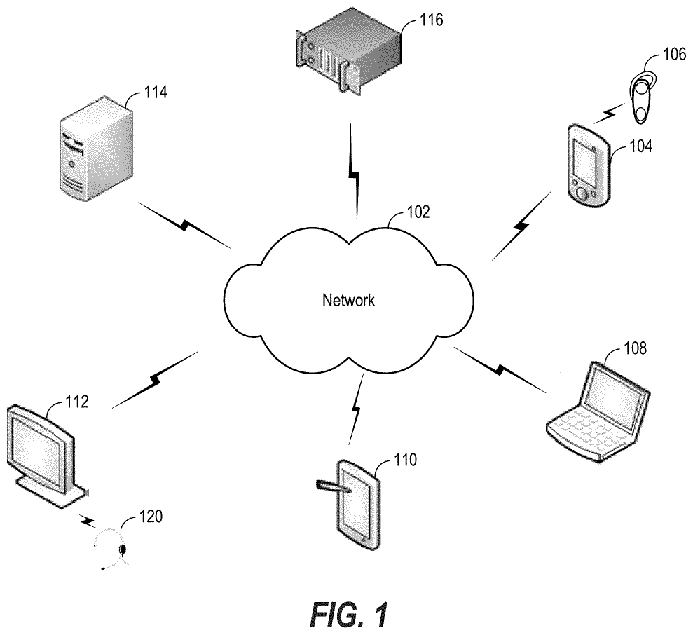

FIG. 1 illustrates a computer network 102 for use with website translation processing, according to one aspect of the present disclosure. Multiple computing devices (e.g., mobile devices, user equipments, personal computers, laptop, tablet, etc.) engaging in website translation processing may be connected over a network. As shown in FIG. 1, multiple devices may be connected over the network 102. The network 102 may include a local or private network or may include a wide network such as the Internet. Devices may be connected to the network 102 through either wired or wireless connections. For example, a wireless device 104 may be connected to the network 102 through a wireless service provider. Other devices, such as computer 112, may connect to the network 102 through a wired connection. Other devices, such as a laptop 108 or tablet computer 110 may be capable of connecting to the network 102 using various connection methods including through a wireless service provider, over a WiFi connection, or the like. Networked devices may output website content supported by a remote server through displays, interfaces or vocally through audio output devices such as headsets 106 or 120. Audio output devices may be connected to networked devices either through a wired or wireless connection. Networked devices may also include embedded audio output devices, such as an internal speaker in the laptop 108, wireless device 104, or tablet computer 110.

In certain system configurations, a combination of devices may be used. For example, one device (e.g., a computing device) may receive website content (e.g., text), another device (e.g., a server) may translate the website content, and still another device may output the translated website content into audio. For example, text of the website content may be received by the wireless device 104 and sent to a computer 114 or server 116 for translation processing and/or text-to-voice or voice-to-text processing. The resulting translation data may be returned to the wireless device 104 for output through the display, output interface, or headset 106 of the wireless device 104.

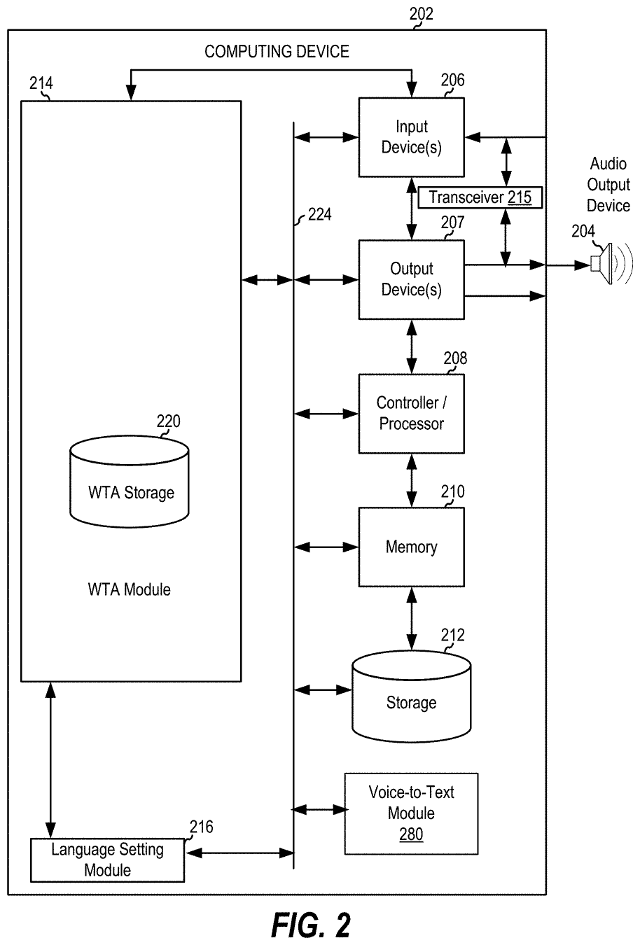

FIG. 2 is a block diagram conceptually illustrating a computing device 202, according to one aspect of the present disclosure. Aspects of the present disclosure include computer-readable and computer-executable instructions that may reside on the computing device 202. FIG. 2 illustrates a number of components that may be included in the computing device 202, however, other non-illustrated components may also be included. Additionally, some of the illustrated components may not be present in every device capable of employing aspects of the present disclosure. Further, some components that are illustrated in the computing device 202 as a single component may also appear multiple times in a single device.

For example, the computing device 202 may include multiple input devices 206, output devices 207, or multiple controllers/processors 208. The computing device 202 may include real-time website translation application (RWTA) features. For example, the computing device 202 may include a website translation application module 214 to facilitate communication with a RWTA server for the translation of the content of a website that is downloaded by the computing device 202. The website translation application module 214 may cause the computing device 202 to transmit the content of the website to the RWTA server for the translation process.

In other aspects, content from the website in a language that is different from a language used by a user of the computing device 202 may be temporarily or transitionally stored in RWTA storage 220 (or a memory 210 or data storage component 212) of the computing device 202 prior to being transmitted to the RWTA server for website translation. The computing device 202 further includes a voice-to-text module 280 for converting voice-to-text and vice versa.

The computing device 202 also includes a transceiver 215. The transceiver 215 is coupled to one or more antennas (not shown). The transceiver 215 enables the computing device 202 to communicate (e.g., transmit to and receive from other computing devices and servers including a translation server and a RWTA server) with various other apparatus over a transmission medium (e.g., the network 102).

The aspects of the present disclosure may be applied within a number of different devices and computer systems, including, for example, general-purpose computing systems, server-client computing systems, mainframe computing systems, telephone computing systems, laptop computers, cellular phones, personal digital assistants (PDAs), tablet computers, other mobile devices, etc. The aspects of the present disclosure may also be applied to home appliances (e.g., refrigerators, ovens, etc.), vehicles (e.g., cars, buses, motorcycles, etc.), and/or ebook readers, for example.

As illustrated in FIG. 2, the computing device 202 may include an audio output device 204 for outputting speech or voice to a server (e.g., a RWTA server, a translation server, and/or a voice-to-text server) processed by the computing device 202. The audio output device 204 may include a speaker, headphone, or other suitable component for emitting sound. The audio output device 204 may be integrated into the computing device 202 or may be separate from the computing device 202. The computing device 202 may also include an address/data bus 224 for conveying data among components of the computing device 202. Each component within the computing device 202 may also be directly connected to other components in addition to (or instead of) being connected to other components across the bus 224. Although certain components are illustrated in FIG. 2 as directly connected, these connections are illustrative only and other components may be directly connected to each other (e.g., the website translation application module 214 to the controller/processor 208).

The computing device 202 may include the controller/processor 208 that may be a central processing unit (CPU) for processing data and computer-readable instructions and the memory 210 for storing data and instructions. The memory 210 may include volatile random access memory (RAM), non-volatile read only memory (ROM), and/or other types of memory. The computing device 202 may also include the data storage component 212 for storing data and instructions. The data storage component 212 may include one or more storage types such as magnetic storage, optical storage, solid-state storage, etc.

The computing device 202 may also be connected to removable or external memory and/or storage (such as a removable memory card, memory key drive, networked storage, etc.) through the input device 206 or the output device 207. Computer instructions for processing by the controller/processor 208 for operating the computing device 202 and its various components may be executed by the controller/processor 208 and stored in the memory 210, storage 212, external device, or in RWTA storage 220 included in the website translation application module 214. Alternatively, some or all of the executable instructions may be embedded in hardware or firmware in addition to or instead of software. The aspects of this disclosure may be implemented in various combinations of software, firmware, and/or hardware, for example. The website translation application module 214 may be a plugin that is downloaded by the computing device when the user of the computing device subscribes to the website translation processing associated with the RWTA server.

The computing device 202 includes the input device(s) 206 and the output device(s) 207. A variety of input/output device(s) may be included in the device. Example input devices include an audio output device 204, such as a microphone, a touch input device, a keyboard, a mouse, a stylus, or other input devices. Example output devices include a visual display, a tactile display, audio speakers, headphones, printer, or other output device. The input device(s) 206 and/or output device(s) 207 may also include an interface for an external peripheral device connection such as universal serial bus (USB), FireWire, Thunderbolt, or other connection protocol. The input device(s) 206 and/or output device(s) 207 may also include a network connection such as an Ethernet port, modem, etc.

The input device(s) 206 and/or output device(s) 207 may also include a wireless communication device, such as radio frequency (RF), infrared, Bluetooth, wireless local area network (WLAN) (such as WiFi), or wireless network radio, such as a radio capable of communication with a wireless communication network such as a long term evolution (LTE) network, 3G network, 4G network, 5G network, etc. Through the transceiver 215, the input device(s) 206, the output device(s) 207, and/or the computing device 202 may connect to a network, such as the Internet or private network, which may include a distributed computing environment.

In some aspects, the website translation application module 214 may cause at least a portion of the content downloaded by the computing device 202 to be transmitted to the RWTA server and/or the translation server. The website translation application module 214 may be connected to the bus 224, input device(s) 206, output device(s) 207, transceiver 215, audio output device 204, controller/processor 208, and/or other components of the computing device 202. The website content may be in the form of text or HTML code that are provided to a server to facilitate translation of the content of the website in a different language.

In one aspect, the language associated with the computing device 202 may be detected based on a language setting in a language setting module 216 and communicated to the website translation application module 214. The website translation application module 214 communicates an indication of the language associated with the computing device 202 or a language associated with a user of the computing device 202 to the server (e.g., the RWTA server). In one aspect, the website translation application module 214 decides whether to transmit some or all of the content of the website. In some aspects, the website owner(s) may select the portions of the website content to be translated while other content are prevented from being translated. Some examples of items that may not want to be translated are customer reviews, quotes, news articles, letters, product titles, business names, personal information, contact information, etc.

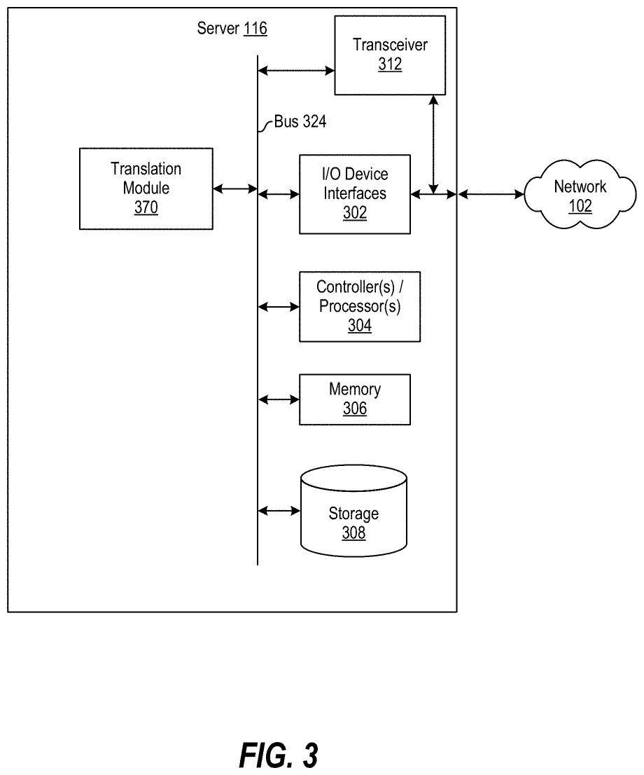

FIG. 3 is a block diagram conceptually illustrating example components of a remote device, such as a remote server 116 (shown in FIG. 1) that may assist with website translation processing. Multiple such servers 116 may be included in a system, such as one server 116 dedicated to translation, another server 116 for hosting the translation application features, etc. In operation, the server 116 may include computer-readable and computer-executable instructions that reside on the server 116.

The server 116 may also include a translation module 370 for translating text or website content from a first language to a second different language. Processing in the server 116 may be performed by a translation module 370, or other components of the server 116 connected via the network 102.

The server 116 may include one or more controller(s)/processor(s) 304 that may each include a central processing unit (CPU) for processing data and computer-readable instructions and a memory 306 for storing data and instructions of the respective device. The memories 306 may individually include volatile random access memory (RAM), non-volatile read only memory (ROM), non-volatile magneto-resistive (MRAM), and/or other types of memory. The server 116 also includes a data storage component 308, for storing data (e.g., audio) and controller/processor-executable instructions. Each data storage component may individually include one or more non-volatile storage types such as magnetic storage, optical storage, solid-state storage, etc. The server 116 may also be connected to removable or external non-volatile memory and/or storage (such as a removable memory card, memory key drive, networked storage, etc.) through input/output device interfaces 302.

The server 116 also includes or is coupled to a transceiver 312. The transceiver 312 is coupled to one or more antennas (not shown). The transceiver 312 enables the server to communicate (e.g., transmit to and receive from the computing devices and other servers including a translation server) with various other apparatus over a transmission medium (e.g., the network 102).

Computer instructions for operating the server 116 and its various components may be executed by the controller(s)/processor(s) 304, using the memory 306 as temporary “working” storage at runtime. A device's computer instructions may be stored in a non-transitory manner in the non-volatile memory 306, the storage 308, or an external device(s). Alternatively, some or all of the executable instructions may be embedded in hardware or firmware on the respective device in addition to or instead of software.

The server 116 includes input/output device interfaces 302. A variety of components may be connected through the input/output device interfaces 302. Additionally, the server 116 may include an address/data bus 324 for conveying data among components of the device. Each component within the server 116 may also be directly connected to other components in addition to (or instead of) being connected to other components across the bus 324.

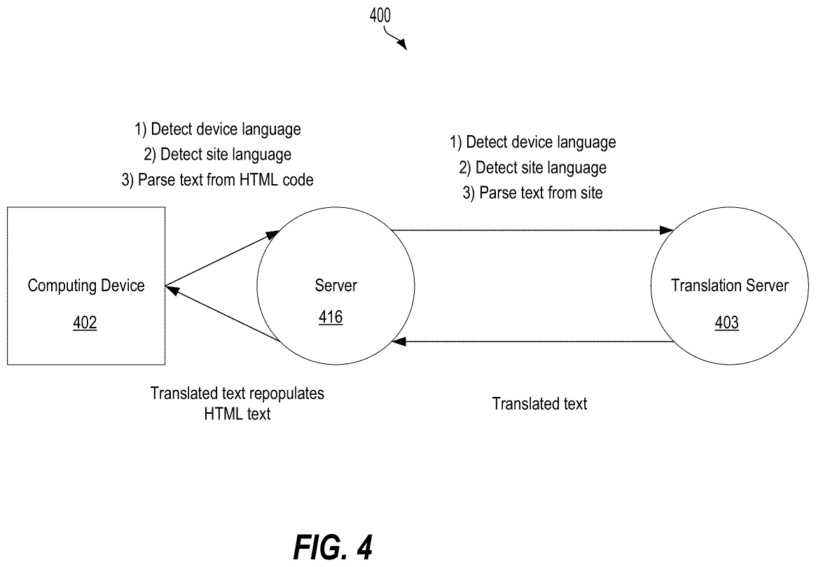

FIG. 4 illustrates a system 400 for translating some or all website content into a preferred language of a viewer, according to aspects of the present disclosure. The system 400 includes a computing device 402, a translation server 403, and a RWTA server 416 coupled to each other. In one aspect, the RWTA server 416 is between the computing device 402 and the translation server 403.

Aspects of the present disclosure are directed to translating some or all of the website content into a preferred language of a user or viewer of the computing device 402. In one aspect, the preferred language corresponds to a native language of the computing device 402 (e.g., a user equipment, mobile device, personal computer, etc.). The computing device 402 includes the real-time website translation application (RWTA) features, according to aspects of the present disclosure.

In one aspect of the present disclosure, the translation of the website content is based on a language of the computing device 402 or a preferred language of the user. The computing device 402 detects a native language of the computing device 402 to which the website content is to be translated. The native language may be set in the settings of the computing device 402. For example, the language associated with the computing device 402 may be detected based on a language setting in a language setting module (e.g., the language setting module 216 of FIG. 2) and communicated to the RWTA server 416 for the translation of some or all of the website content into the native language. For example, each item to be translated includes an identification (e.g., an HTML tag identification (ID)). This identification is used by RWTA server to determine the website content (e.g., words and phrases) to be sent to the translation server for translation.

In one aspect, a request for loading a website on a browser is detected/determined at the computing device 402. For example, after detecting the preferred language, text associated with or downloaded from the website at a browser of the computing device 402 is transmitted to the RWTA server 416. The text may be text from code (e.g., hypertext markup language (HTML) code) used to generate the content of the website. The text may include all or part of the content of the website. The computing device 402 detects a website language of the content of the website and provides an indication of the website language and the native language to the RWTA server 416. For example, the computing device may include a language detector (not shown) to detect the website language.

In one aspect, the computing device 402 transmits code (e.g., HTML code) associated with the website content to the RWTA server 416. In other aspects, the computing device 402 transmits text of the website content to the RWTA server 416. When the RWTA server 416 receives code from the computing device 402, the RWTA server 416 parses text from the code (e.g., convert from code to text) prior to sending the web content to the translation server 403.

The RWTA server 416 passes the text to the translation server 403 for translation. In addition to the text, the RWTA server 416 sends a “to” and “from” indicator. The “from” indicates the source language and the “to” indicates the translation language. For example, the RWTA server 416 sends, to the translation server 403, an indication of the preferred language to which the website content is to be translated and the current language of the website content. The translation server 403 then returns the translated text to the RWTA server and/or the computing device 402. The translated text replaces the original text of the website. The text of the website is displayed in the native language. For example, the translated text repopulates the HTML text.

Translating some or all website content into a preferred language of a user or viewer are performed without user input. For example, the detecting of the native language, the determining of a request to load a website on a browser of the computing device, the transmitting of text from the website, transmitting of an indication of the native language, the transmitting of an indication of the website language to the RWTA server, the receiving of the text translated to the native language, and the displaying of the website in the native language are performed automatically and without user input.

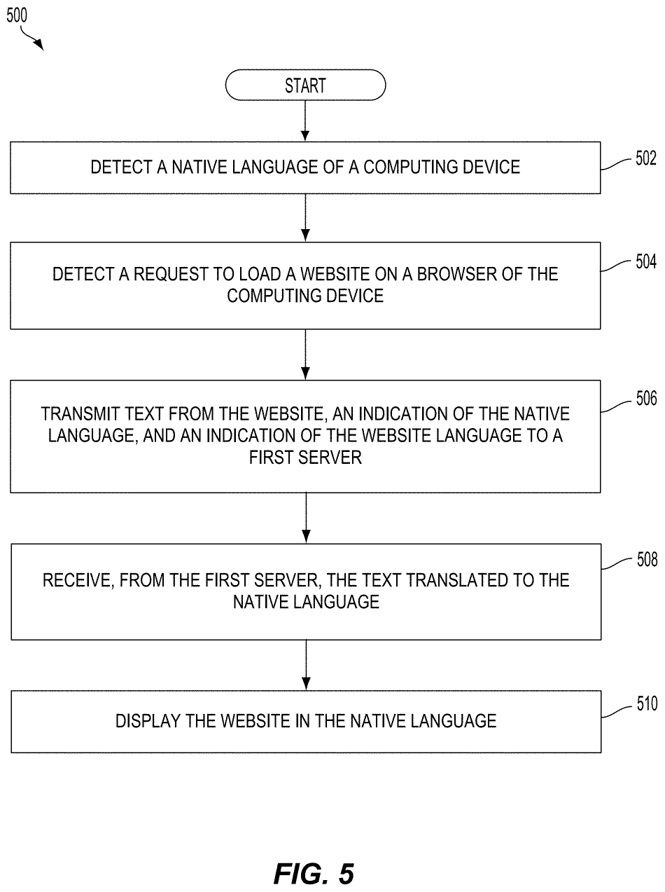

FIG. 5 depicts a simplified flowchart of a method 500 for translating, in real-time, some or all website content into a preferred language of the viewer, according to aspects of the present disclosure. At block 502, a computing device detects a native language of the computing device. At block 504, the computing device detects/determines a request to load a website on a browser of the computing device. At block 506, the computing device transmits text from the website, an indication of the native language, and an indication of a website language to a first server. At block 508, the computing device receives, from the first server, the text translated to the native language. At block 510, the computing device displays the website in the native language.

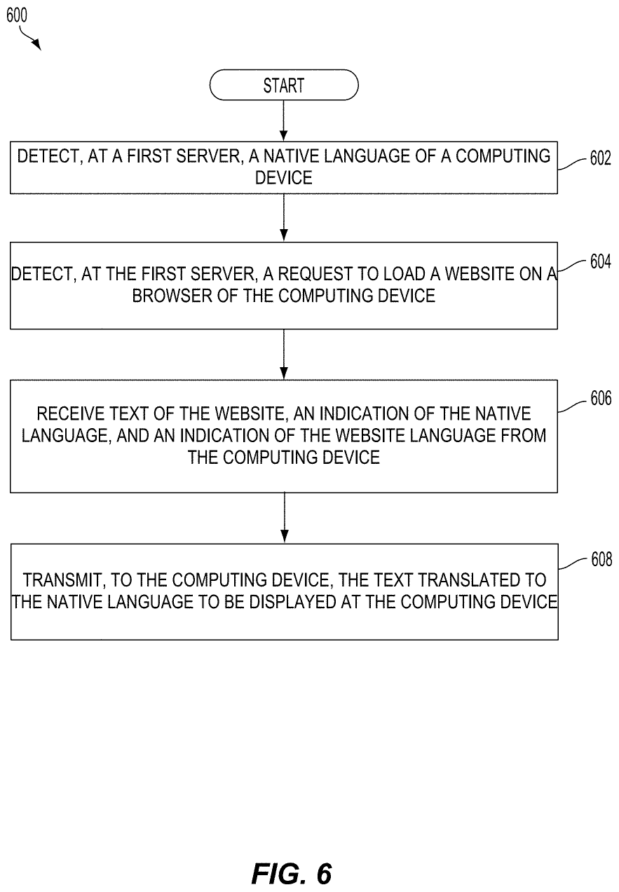

FIG. 6 depicts a simplified flowchart of a real-time website translation 600, according to aspects of the present disclosure. At block 602, a first server (e.g., a RWTA server) detects a native language of the computing device. At block 604, the first server detects/determines a request to load a website on a browser of the computing device. At block 606, the first server receives text of the website, an indication of the native language, and an indication of a website language transmitted from the computing device. At block 608, the first server transmits the text translated to the native language to be displayed at the computing device.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a RWTA server having signals indicative of instructions and data. The instructions and data are configured to cause one or more processors to implement the functions outlined in the claims.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

Although the present disclosure and its advantages have been described in detail, it should be understood that various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, and composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A real-time website translation method, comprising:
detecting, at a computing device, a native language of the computing device;
detecting, at the computing device, a request to load a website on a browser of the computing device;
transmitting text from the website, an indication of the native language, and an indication of a website language to a first server;
receiving, from the first server, the text translated to the native language; and
displaying the website in the native language.

2. The method of claim 1, in which the website language is different from the native language.

3. The method of claim 1, further comprising determining the website language.

4. The method of claim 1, in which the translated text is received via the first server, which receives the translated text from a translation server after transmitting the text from the website, the indication of the native language, and the indication of the website language to the translation server for translation.

5. The method of claim 1, in which the detecting, transmitting, receiving, and displaying are performed without user input.

6. A real-time website translation apparatus comprising:
a memory; and
at least one processor coupled to the memory, the at least one processor configured:
to detect a native language of a computing device;
to detect a request to load a website on a browser of the computing device;
to transmit text from the website, an indication of the native language, and an indication of a website language to a first server;
to receive, from the first server, the text translated to the native language; and
to display the website in the native language.

7. The apparatus of claim 6, in which the website language is different from the native language.

8. The apparatus of claim 6, in which the at least on processor is further configured to determine the website language.

9. The apparatus of claim 6, in which the translated text is received via the first server, which receives the translated text from a translation server after transmitting the text from the website, the indication of the native language, and the indication of the website language to the translation server for translation.

10. The apparatus of claim 6, in which the detecting, transmitting, receiving, and displaying are performed without user input.

11. A real-time website translation apparatus, comprising:
detecting, at a first server, a native language of a computing device;
detecting, at the first server, a request to load a website on a browser of the computing device;
receiving text of the website, an indication of the native language, and an indication of a website language transmitted from the computing device;
transmitting, to the computing device, the text translated to the native language to be displayed at the computing device.

12. The apparatus of claim 11, in which the website language is different from the native language.

13. The apparatus of claim 11, further comprising determining the website language.

14. The apparatus of claim 11, in which the translated text is received at the first server from a translation server after the first server transmits the text from the website, the indication of the native language, and the indication of the website language to the translation server for translation.

15. The apparatus of claim 11, in which the detecting, transmitting, and receiving are performed without user input.

16. A real-time website translation apparatus comprising:
a memory; and
at least one processor coupled to the memory, the at least one processor configured:
to detect a native language of a computing device;
to detect a request to load a website on a browser of the computing device;
to receive text of the website, an indication of the native language, and an indication of a website language transmitted from the computing device;
to transmit the text translated to the native language to be displayed at the computing device.

17. The apparatus of claim 16, in which the website language is different from the native language.

18. The apparatus of claim 16, in which the at least one processor is further configured to determine the website language.

19. The apparatus of claim 16, in which the at least one processor is further configured to receive the translated text from a translation server after the transmitting of the text from the website, the indication of the native language, and the indication of the website language to the translation server for translation.

20. The apparatus of claim 16, in which the detecting, transmitting, and receiving are performed without user input.
